(19) United States
(12) Patent Application Publication
(10) Pub. No.: US 2024/0236714 A1
(43) Pub. Date: Jul. 11, 2024

(54) SIDELINK TRIGGERED MINIMIZATION OF DRIVE TEST (MDT) LOGGING

(71) Applicant: Telefonaktiebolaget LM Ericsson (publ), Stockholm (SE)

(72) Inventors: Santhan THANGARASA, Vällingby (SE); Muhammad Ali KAZMI, Sundbyberg (SE)

(21) Appl. No.: 18/558,658

(22) PCT Filed: May 6, 2021
(86) PCT No.: PCT/SE2021/050422

§ 371 Date: Nov. 2, 2023

(51) Int. Cl. H04W 24/02; H04W 24/10; H04W 92/18

(52) U.S. Cl. CPC H04W 24/02; H04W 24/10; H04W 92/18

(57) ABSTRACT

According to one or more embodiments, a wireless device is provided. The wireless device includes processing circuitry configured to: determine whether a sidelink operational criterion is met, and initiate logging of minimization of drive test, MDT, data based at least on determining that the sidelink operational criterion is met. According to one or more embodiments, a network node is provided. The network node includes processing circuitry configured to: configure a wireless device with a sidelink operational criterion where the sidelink operational criterion is configured to initiate logging of minimization of drive test, MDT, data at the wireless device based at least on the sidelink operational criterion being met, receive MDT data, and perform at least one action based on the received MDT data.

### TECHNICAL FIELD

Wireless communication and in particular, sidelink based triggering of wireless device measurements such as minimization of drive test (MDT) based measurements.

### BACKGROUND

### New Radio (NR) Overview

In NR (also referred to as 5^{th} Generation (5G)), which is based on orthogonal frequency division multiplexing (OFDM), multiple numerologies are supported for operation, e.g., transmission and/or reception of signals. The term numerology may refer to any one or more of: frame duration, subframe or transmission time interval (TTI) duration, slot duration, min-slot duration, symbol durations subcarrier spacing, number of resource blocks (RBs) within the bandwidth, number of subcarriers per physical channel (e.g., per RB), cyclic prefix (CP) length (e.g., normal and extended CP lengths), etc. A scaling approach (based on a scaling factor 2^{N}, N=1, 2, . . . ) is considered for deriving subcarrier spacings for NR: 15 kHz, 30 kHz, 60 kHz, 120 kHz, 240 kHz, etc. The numerology-specific time resource durations (e.g., slot, subframe, etc.) can then be determined based on the subcarrier spacing: subcarrier spacing of (2^{N}*15) kHz corresponds to a symbol duration of 1/(15000*2^{N}) second.

Furthermore, NR supports a large number of bandwidths, which depends on the frequency range of signals transmitted in the cell. Examples of frequency ranges are frequency range 1 (FR1) and frequency range 2 (FR2). In FR1, the frequencies are lower than the frequencies belonging to FR2. An example of FR1 includes a range of frequencies up to 7 GHz. An example of FR2 includes a range of frequencies between 24 and 52.6 GHz. In FR1, examples of supported bandwidths are 5 MHz, 10 MHz, 20 MHz, 30 MHz, 40 MHz, 50 MHz, 80 MHz, 100 MHZ, etc. In FR2, examples of supported bandwidths are 50 MHz, 100 MHz, 200 MHZ, 400 MHZ, etc.

### Vehicle-to-Everything (V2X) Communication

V2X is a special type of device to device (D2D) operation. The D2D operation is a generic term that may refer to transmission and/or reception of any type of D2D signals (e.g., physical signals, physical channel, etc.) by a D2D communication capable wireless device and/or by D2D discovery capable wireless device. D2D operation is therefore also referred to as D2D transmission, D2D reception, D2D communication, proximity services (ProSe), V2X, etc.

V2X communication includes any combination of direct communication between vehicles, pedestrians and infrastructure. Therefore, X may denote “vehicular” (i.e., V2V) or X may denote “pedestrian” (i.e., V2P) or X may denote “network” (i.e., V2N), “infrastructure” (i.e., V2I) and so on.

V2X communication takes place on radio resources on sidelink (SL). The SL can be configured on a dedicated carrier (e.g., in a carrier of intelligent transport systems (ITS) band) or a carrier of the serving cell of the wireless device. In the latter case, the SL resources and resources for cellular communication (over uplink/downlink, also known as Uu link) are shared in time and/or frequency. Typically, the SL resources are time multiplexed with the uplink resources used for cellular communication on the serving cell of the wireless device. A C-ITS environment is illustrated in the diagram of FIG. 1.

Broadcast, groupcast, and unicast transmissions for V2X operation on the SL are supported for the in-coverage, out-of-coverage and partial-coverage scenarios. For unicast and groupcast transmissions on SL, hybrid automatic repeat request (HARQ) feedback and HARQ combining in the physical layer of the wireless device are supported.

### MDT

Minimization of drive test (MDT) is used as an alternative to the drive tests for obtaining certain types of wireless device measurements results for self-organizing network (SON) related features such as network planning, network optimization, network parameter tuning or setting (e.g., network node transmit power, number of receive and/or transmit antennas, etc.), or even for positioning (e.g., radio frequency (RF) pattern matching based positioning). The wireless device is configured by the network for logging the measurements. Two MDT modes exist: immediate MDT and logged MDT:
Immediate MIDT corresponds to measurements performed by wireless device in the high radio resource control (RRC) activity states (e.g., RRC CONNECTED state in Long Term Evolution (LTE, also referred to as 4^{th} Generation (4G)) and NR, etc.) and the reporting of the measurements to a network node (e.g., eNodeB, gNode B, etc.) when reporting condition is met, e.g., event is triggered.
Logged MDT functionality corresponds to measurements performed by a wireless device when operating in a low RRC activity state (e.g., RRC idle, RRC inactive, etc.). The network node uses Logged Measurement Configuration message to configure the wireless device to perform logging of measurement results in low RRC activity state which can be stored in the wireless device for up to, for example, 48 hours before reporting. The configuration message includes information such as absolute time in the cell, logging duration, logging interval or periodicity (e.g., how often the measurements are logged), information about area where logging is required, etc. The logging duration can vary from few minutes to several hours. The wireless device transmits the measurement results along with relative time stamp for each log, which indicates the time of logging measurement results relative to the absolute time received (received from the network node), location information of the logged results (optional), etc.

Self-organizing network (SON) operation which includes MDT measurements are supported in NR since NR release 16 and in LTE since early LTE release. These existing MDT measurements rely on the mobile broadband (MBB) wireless device mobility profile, i.e., they are logged in areas where the wireless device can reach. The mobility profile of MBB wireless device (e.g., handheld device) has certain characteristics which are different compared to the mobility profile of a V2X (e.g., SL capable) wireless device which is typically embedded in a vehicle. For example, the notable characteristics of V2X wireless device operation includes:
operating while moving in different roads and highways in different areas than typical MBB wireless device;
operating at much higher speed (than typical MBB wireless device) at which vehicles drive on motorways;
operating reliably while driving on all types of roads, e.g., continuously or periodically or frequently; and
operating (e.g., on SL), even when there is no cellular coverage or when a vehicle is in poor cellular coverage.

On the other hand, a MBB wireless device is not guaranteed to be operating in all vehicular scenarios listed above all the time. For example, the existing solutions (e.g., physical and higher layer design) are tailored to operate MBB wireless devices in scenarios suitable for typical users, e.g., in hotspots, at low/moderate speed, high and reliable data acquisition in-home/local areas, etc. That is, an MBB wireless device profile is not very useful for vehicle-based wireless devices.

Another difference between MBB and V2X SL is that V2X SL wireless devices are embedded inside the vehicle such that the V2X SL wireless devices do not have the limitation of battery power. Therefore, a MBB wireless device cannot guarantee some of the advantages that SL vehicular wireless devices can provide for SON related measurements. In order to efficiently serve wireless devices in typical vehicular environment (e.g., motorways, tunnels, etc.), the deployment of radio nodes and network parameter setting need to be customized to the vehicular radio environment. Existing network planning solutions that rely on classical MDT logging principles are not suitable for the planning, deploying and tuning of the radio network in the vehicular environment.

### SUMMARY

Some embodiments advantageously provide a method and system for sidelink based triggering of wireless device measurements such as MDT based measurements.

According to a first aspect of a first embodiment related to a method performed by a wireless device, the wireless device is configured to log MDT data when the wireless device is also configured with SL operation.

The wireless device is configured with SL operation when at least one of following conditions is met (i.e., a sidelink operational criterion is met):
When the wireless device is configured with SL operation by the higher layer, e.g., SL is ready for transmission/reception of signals, but it may or may not be operating the signals at a given time.
When the wireless device is actively operating SL, e.g., transmitting/receiving one or more SL signals.
When the wireless device is configured with particular SL operation mode (e.g., unicast, multicast, broadcast, etc.) by the higher layer but it may or may not be operating the signals at a given time.
When the wireless device is actively operating in particular SL operation mode(s). Examples of such as modes are unicast SL operation, multicast SL operation, broadcast SL operation, etc.

The MDT data may include at least the results of measurements performed on one or more signals and/or channels and associated information such as when the measurement is performed. Examples of measurements are signal strength, signal quality, block error rate (BLER), etc. Examples of information associated with measurements are cell identifier (ID), time stamp or relative time stamp when the measurement is performed, SL status, SL mode, network coverage status of the wireless device (e.g., in-network, out-of-network, etc.), etc.

According to a second aspect of the first embodiment related to a method performed in a wireless device, the wireless device is configured to stop or pause or suspend the ongoing logging of MDT data when one or more of the following conditions is met (i.e., a sidelink operational criterion is not met):
When the SL operation is de-configured. This occurs when none of the conditions to configure SL operation in the first embodiment is met.
After the expiry of a timer which started upon starting the logging of the MDT.

When configured to pause or suspend the logging of MDT data, the wireless device temporarily stops or suspends the ongoing MDT logging. In these cases, the wireless device may restart the MDT logging after the pause duration, e.g., as long as the MDT logging timer (e.g., T330 timer that is a well known timer) is running.

According to one aspect of the present disclosure, a wireless device is provided. The wireless device includes processing circuitry configured to determine whether a sidelink operational criterion is met, and initiate logging of minimization of drive test, MIDT, data based at least on determining that the sidelink operational criterion is met.

According to one or more embodiments, the sidelink operational criterion is determined to be met based on the wireless device being configured for a sidelink operation. According to one or more embodiments, the sidelink operational criterion is determined to be met based on the wireless device actively performing a sidelink operation. According to one or more embodiments, the sidelink operational criterion is determined to be met based on the sidelink operation being associated with a first sidelink operational mode of a plurality of sidelink operational modes.

According to one or more embodiments, the first sidelink operational mode is one of a unicast operational mode, multicast operational mode, broadcast operational mode, dedicated carrier operational mode and shared carrier operational mode. According to one or more embodiments, the processing circuitry is further configured to one of pause and stop the logging of MDT data based at least on one of the sidelink operational criterion no longer being met, and expiration of a timer. According to one or more embodiments, the processing circuitry is configured to start the timer in response to initiating the logging of MDT data. According to one or more embodiments, the MDT data includes a sidelink coverage status that indicates a type of network coverage the wireless device operates under at a time of logging of MDT data where the type of network coverage includes one of in-coverage, out-of-coverage and partial coverage.

According to one or more embodiments, the MDT data includes a sidelink status that indicates whether the wireless device at least one of transmits and receives sidelink signals at the time of logging of MDT data. According to one or more embodiments, the MDT data indicates a sidelink operational mode implemented by the wireless device where the sidelink operational mode is one of a unicast operational mode, multicast operational mode, broadcast operational mode, dedicated carrier operational mode and shared carrier operational mode. According to one or more embodiments, the processing circuitry is further configured to receive the sidelink operational criterion from a network node for implementation.

According to one or more embodiments, the MDT data further includes at least one of: a cellular measurement result, a sidelink measurement result, a cell identifier of a cell on which the cellular measurement is performed, information associated with a sidelink wireless device on which a sidelink measurement is performed, a time when the sidelink operational criterion is met, a time when the MDT data is logged, wireless device mobility status when the MDT data is logged, wireless device location information when the MDT data is logged, and a duration over which the MDT data is logged. According to one or more embodiments, the processing circuitry is further configured to cause transmission of MDT data to the network node for use in performing at least one action.

According to another aspect of the present disclosure, a network node includes processing circuitry configured to configure a wireless device with a sidelink operational criterion where the sidelink operational criterion is configured to initiate logging of minimization of drive test, MDT, data at the wireless device based at least on the sidelink operational criterion being met, receive MDT data, and perform at least one action based on the received MDT data.

According to one or more embodiments, the sidelink operational criterion is met based on the wireless device being configured for a sidelink operation. According to one or more embodiments, the sidelink operational criterion is met based on the wireless device actively performing a sidelink operation. According to one or more embodiments, the sidelink operational criterion is met based on the sidelink operation being associated with a first sidelink operational mode of a plurality of sidelink operational modes. According to one or more embodiments, the first sidelink operational mode is one of a unicast operational mode, multicast operational mode, broadcast operational mode, dedicated carrier operational mode and shared carrier operational mode.

According to one or more embodiments, the sidelink operational criterion is configured to one of pause and stop the logging of MDT data based at least on one of the sidelink operational criterion no longer being met, and expiration of a timer at the wireless device. According to one or more embodiments, the MDT data includes a sidelink coverage status that indicates a type of network coverage the wireless device operates under at a time of logging of MDT data, the type of network coverage includes one of in-coverage, out-of-coverage and partial coverage. According to one or more embodiments, the MDT data includes a sidelink status that indicates whether the wireless device at least one of transmits and receives sidelink signals at a time of logging of MDT data. According to one or more embodiments, the MDT data indicates a sidelink operational mode implemented by the wireless device where the sidelink operational mode is one of a unicast operational mode, multicast operational mode, broadcast operational mode, dedicated carrier operational mode and shared carrier operational mode. According to one or more embodiments, the MDT data further includes at least one of: a cellular measurement result, a sidelink measurement result, a cell identifier of a cell on which the cellular measurement is performed, information associated with a sidelink wireless device on which a sidelink measurement is performed, a time when the sidelink operational criterion is met, a time when the MDT data is logged, wireless device mobility status when the MDT data is logged, wireless device location information when the MDT data is logged, and a duration over which the MDT data is logged.

According to another aspect of the present disclosure, a method implemented by a wireless device is provided. A determination is performed as to whether a sidelink operational criterion is met. Logging of minimization of drive test, MDT, data is initiated based at least on determining that the sidelink operational criterion is met.

According to one or more embodiments, the sidelink operational criterion is determined to be met based on the wireless device being configured for a sidelink operation. According to one or more embodiments, the sidelink operational criterion is determined to be met based on the wireless device actively performing a sidelink operation. According to one or more embodiments, the sidelink operational criterion is determined to be met based on the sidelink operation being associated with a first sidelink operational mode of a plurality of sidelink operational modes. According to one or more embodiments, the first sidelink operational mode is one of a unicast operational mode, multicast operational mode, broadcast operational mode, dedicated carrier operational mode and shared carrier operational mode.

According to one or more embodiments, one of pausing and stopping the logging of MDT data is performed based at least on one of: the sidelink operational criterion no longer being met, and expiration of a timer. According to one or more embodiments, the timer is started in response to initiating the logging of MDT data. According to one or more embodiments, the MDT data includes a sidelink coverage status that indicates a type of network coverage the wireless device operates under at a time of logging of MDT data where the type of network coverage includes one of in-coverage, out-of-coverage and partial coverage.

According to one or more embodiments, the MDT data includes a sidelink status that indicates whether the wireless device at least one of transmits and receives sidelink signals at the time of logging of MDT data. According to one or more embodiments, the MDT data indicates a sidelink operational mode implemented by the wireless device where the sidelink operational mode is one of a unicast operational mode, multicast operational mode, broadcast operational mode, dedicated carrier operational mode and shared carrier operational mode. According to one or more embodiments, the sidelink operational criterion is received from a network node for implementation.

According to one or more embodiments, the MDT data further includes at least one of: a cellular measurement result, a sidelink measurement result, a cell identifier of a cell on which the cellular measurement is performed, information associated with a sidelink wireless device on which a sidelink measurement is performed, a time when the sidelink operational criterion is met, a time when the MDT data is logged, wireless device mobility status when the MDT data is logged, wireless device location information when the MDT data is logged, and a duration over which the MDT data is logged. According to one or more embodiments, transmission is caused of MDT data to the network node for use in performing at least one action.

According to another aspect of the disclosure, a method implemented by a network node is provided. A wireless device is configured with a sidelink operational criterion where the sidelink operational criterion is configured to initiate logging of minimization of drive test, MDT, data at the wireless device based at least on the sidelink operational criterion being met. MDT data is received. At least one action is performed based on the received MDT data.

According to one or more embodiments, the sidelink operational criterion is met based on the wireless device being configured for a sidelink operation. According to one or more embodiments, the sidelink operational criterion is met based on the wireless device actively performing a sidelink operation. According to one or more embodiments, the sidelink operational criterion is met based on the sidelink operation being associated with a first sidelink operational mode of a plurality of sidelink operational modes.

According to one or more embodiments, the first sidelink operational mode is one of a unicast operational mode, multicast operational mode, broadcast operational mode, dedicated carrier operational mode and shared carrier operational mode. According to one or more embodiments, the sidelink operational criterion is configured to one of pause and stop the logging of MDT data based at least on one of: the sidelink operational criterion no longer being met, and expiration of a timer at the wireless device. According to one or more embodiments, the MDT data includes a sidelink coverage status that indicates a type of network coverage the wireless device operates under at a time of logging of MDT data where the type of network coverage includes one of in-coverage, out-of-coverage and partial coverage.

According to one or more embodiments, the MDT data includes a sidelink status that indicates whether the wireless device at least one of transmits and receives sidelink signals at a time of logging of MDT data. According to one or more embodiments, the MDT data indicates a sidelink operational mode implemented by the wireless device where the sidelink operational mode is one of a unicast operational mode, multicast operational mode, broadcast operational mode, dedicated carrier operational mode and shared carrier operational mode. According to one or more embodiments, the MDT data further includes at least one of: a cellular measurement result, a sidelink measurement result, a cell identifier of a cell on which the cellular measurement is performed, information associated with a sidelink wireless device on which a sidelink measurement is performed, a time when the sidelink operational criterion is met, a time when the MDT data is logged, wireless device mobility status when the MDT data is logged, wireless device location information when the MDT data is logged, and a duration over which the MDT data is logged.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a C-ITS environment;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an exemplary process in a network node according to some embodiments of the present disclosure;

FIG. 9 is a flowchart of an exemplary process in a wireless device according to some embodiments of the present disclosure;

FIG. 10 is a diagram of an example scenario where a wireless device starts MDT logging after SL operation is configured according to some embodiments of the disclosure;

FIG. 11 is a diagram of an example scenario where a wireless device starts MDT logging after the configured SL becomes active according to some embodiments of the disclosure;

FIG. 12 is a diagram of an example scenario where a wireless device stops MDT logging after the timer associated with the MDT logging according to some embodiments of the disclosure; and

FIG. 13 is a diagram of an example scenario where MDT logging is suspended and resumed based on MDT logging criteria according to some embodiments of the disclosure.

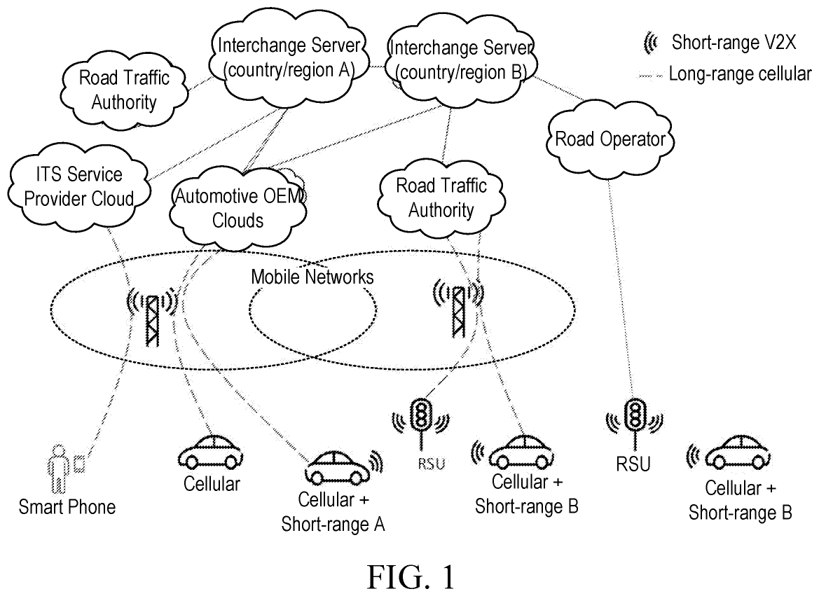

### DETAILED DESCRIPTION

Before describing in detail exemplary embodiments, it is noted that the embodiments reside primarily in combinations of apparatus components and processing steps related to sidelink based triggering of wireless device measurements such as minimization of drive test (MDT) based measurements. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), core network node (e.g., MSC, MME, etc.), O&M, OSS, SON, positioning node (e.g., E-SMLC), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, vehicular to vehicular (V2V), machine type WD, MTC WD or WD capable of machine to machine communication (M2M), low-cost and/or low-complexity WD, a sensor equipped with WD, Tablet, mobile terminals, personal digital assistant, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments, the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH), Central Unit (e.g., in a gNB), Distributed Unit (e.g., in a gNB), digital unit, Baseband Unit, Centralized Baseband, centralized RAN, access point (AP), etc.

The term radio access technology, or RAT, may refer to any RAT, e.g., UTRA, E-UTRA, narrow band internet of things (NB-IOT), WiFi, Bluetooth, next generation RAT, New Radio (NR), 4G, 5G, etc. Any of the equipment denoted by the terms node, network node or radio network node may be capable of supporting a single or multiple RATs.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

The term time resource used herein may correspond to any type of physical resource or radio resource expressed in terms of length of time. Examples of time resources are: symbol, time slot, subframe, radio frame, TTI, interleaving time, etc. The term TTI used herein may correspond to any time period over which a physical channel can be encoded and optionally interleaved for transmission. The physical channel is decoded by the receiver over the same time period over which it was encoded. The TTI may also interchangeably called as short TTI (sTTI), transmission time, slot, sub-slot, mini-slot, mini-subframe, etc.

The term wireless access network (WAN) used herein may correspond to radio network involving communication between a WD and a network node (e.g., base station). WAN is also interchangeably called as a cellular network or mobile network etc. The signals transmitted between the WD and the network node are called herein as WAN signals. The signal transmitted by the WD to the network node is called as UL WAN signal. The signal transmitted by the network node to the WD is called as DL WAN signal. The WAN may also interchangeably be called as cellular network, radio access network (RAN), Uu interface, radio network interface, etc. The corresponding link or radio link over which the WAN signals are transmitted is also called herein as the WAN link, RAN link, Uu link, uplink (UL) (WD transmission to network node), downlink (DL) (network node transmission to WD), forward link (network node transmission to WD), reverse link (WD transmission to network node), etc. Therefore, WAN link can also be WAN UL or UL WAN or WAN DL or DL WAN. The corresponding signals transmitted between the WD and the network node, may also interchangeably be called as cellular signals, Uu signals, RAN signals, etc. The WAN signals may belong to or operate in any type of RAT, e.g., LTE, NR, etc. In the embodiment, the generic term WAN link and WAN signals are used.

The link or radio link over which the signals are transmitted between at least two WDs for D2D operation is called herein as the side link (SL). The signals transmitted between the WDs for D2D operation are referred to herein as SL signals. The term SL may also interchangeably be called as D2D link, V2X link, proximity service (prose) link, peer-to-peer link, PC5 link, direction communication, etc. The SL signals may also interchangeably be referred to as V2X signals, D2D signals, prose signals, PC5 signals, peer-to-peer signals, etc. A generic term SL operation used herein may comprise operating signals over the SL. An operating of signals may comprise transmitting and/or receiving signals over SL. The term operation may be referred to as communication, transmission, reception etc. The SL operation may also be referred to as SL communication, SL transmission, SL reception etc. The SL operation may also be referred to as D2D operation, peer-to-peer operation, prose operation, etc. The SL operation may be unicast operation between a pair of UEs or multicast or broadcast between any number of UEs.

The term MBB WD used here operates (transmits and/or receive) signals between itself and one or more network nodes on uplink and/or downlink.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication, for example, between base stations or similar network nodes, in particular communication terminating at such. It may be considered that backhaul and/or relay communication and/or network communication is implemented as a form of sidelink or uplink communication or similar thereto.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Some embodiments provide sidelink based triggering of wireless device measurements such as MDT based measurements.

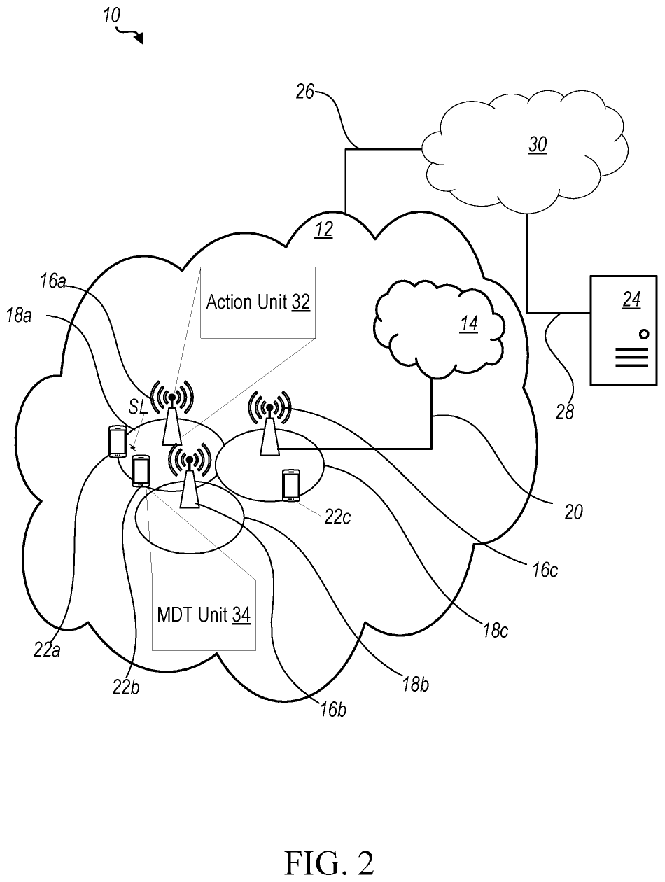

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18a is wirelessly connectable to the corresponding network node 16a. A third WD 22c is wirelessly connectable to the corresponding network node 16c. While a plurality of WDs 22a, 22b and 22c (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b, 22c and the host computer 24. The connectivity may be described as an over-the-top (OTT) connection. The host computer 24 and the connected WDs 22a, 22b, 22c are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an action unit 32 which is configured to perform one or more network node 16 functions such as with respect to sidelink based triggering of wireless device measurements such as MDT based measurements, as described herein. A wireless device 22 is configured to include a MDT unit 34 which is configured to perform one or more wireless device 22 functions such as with respect to sidelink based triggering of wireless device measurements such as MDT based measurements, as described herein.

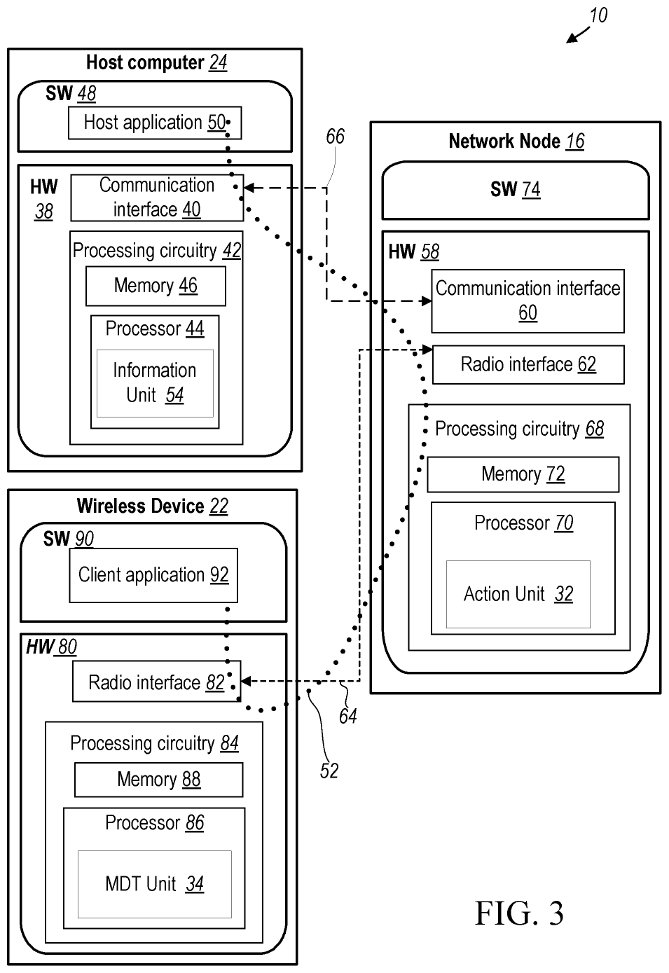

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to transmit, receive, relay, forward, process, analyze, store, determine, compare, etc., information related sidelink based triggering of wireless device measurements such as MDT based measurements.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include action unit 32 configured to perform one or more network node 16 functions such as with respect to sidelink based triggering of wireless device measurements such as MDT based measurements, as described herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a MDT unit 34 configured to perform one or more wireless device 22 functions such as with respect to sidelink based triggering of wireless device measurements such as MDT based measurements, as described herein.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as action unit 32, and MDT unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

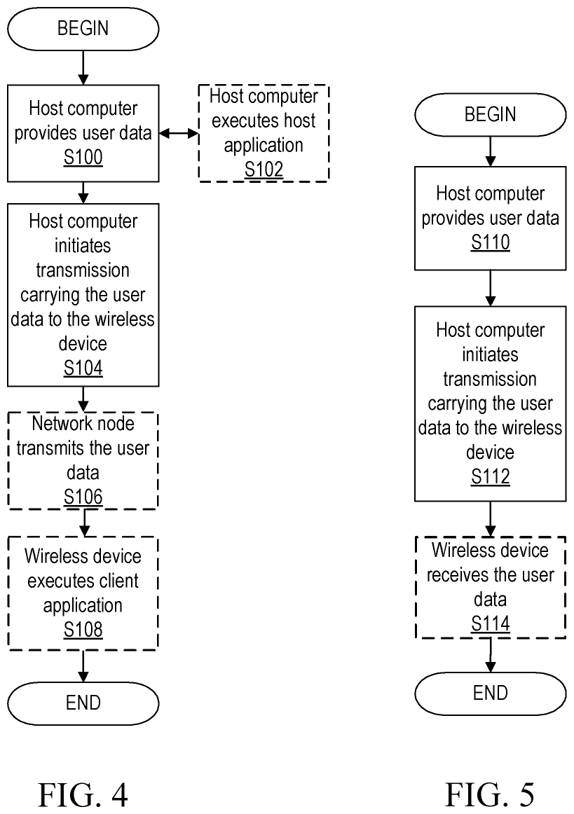

FIG. 4 is a flowchart illustrating an exemplary method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

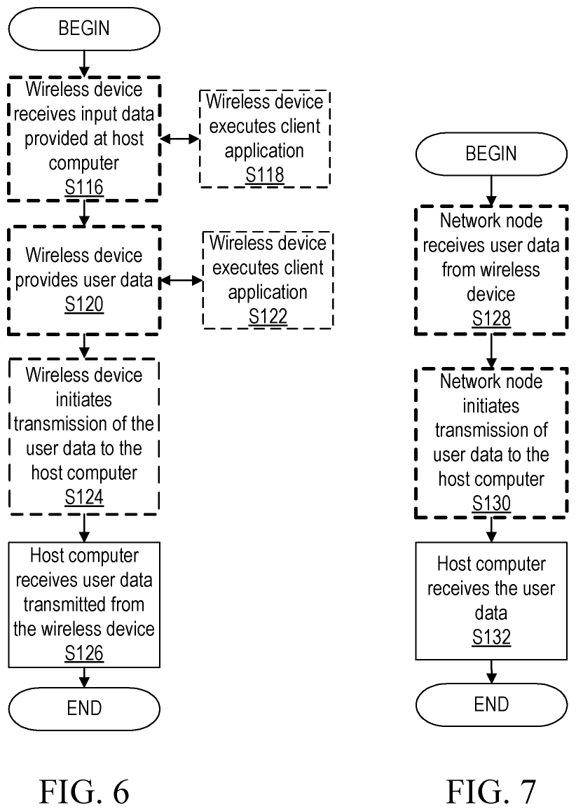

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

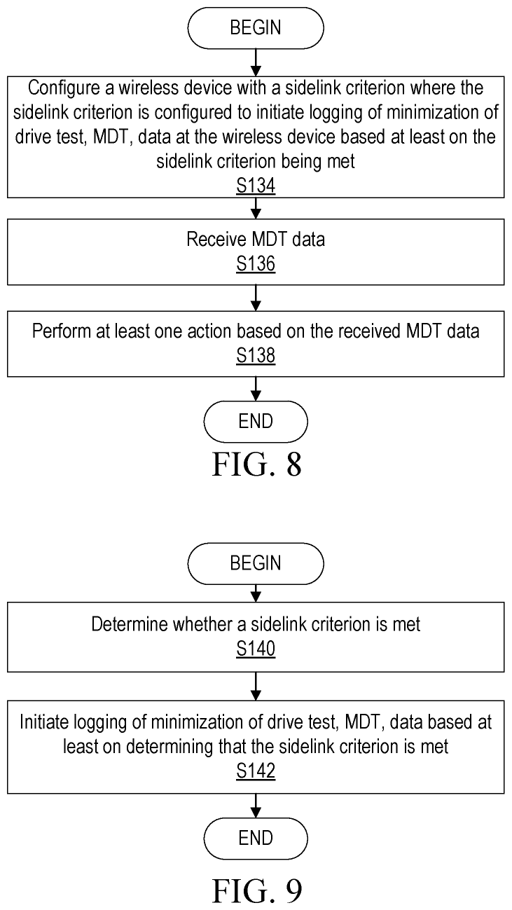

FIG. 8 is a flowchart of an exemplary process in a network node 16 according to some embodiments of the present disclosure. One or more blocks described herein may be performed by one or more elements of network node 16 such as by one or more of processing circuitry 68 (including the action unit 32), processor 70, radio interface 62 and/or communication interface 60. Network node 16 is configured to configure a wireless device 22 with a sidelink criterion where the sidelink criterion is configured to initiate logging of minimization of drive test, MDT, data at the wireless device 22 based at least on the sidelink criterion being met, as described herein. Network node 16 is configured to receive MDT data, as described herein. Network node 16 is configured to perform at least one action based on the received MDT data, as described herein.

According to one or more embodiments, the sidelink criterion is met based on the wireless device 22 being configured for a sidelink operation. According to one or more embodiments, the sidelink criterion is met based on the wireless device 22 actively performing a sidelink operation. According to one or more embodiments, the sidelink criterion is met based on the sidelink operation being associated with a first sidelink operational mode of a plurality of sidelink operational modes.

According to one or more embodiments, the first sidelink operational mode is one of a unicast operational mode, multicast operational mode, broadcast operational mode, dedicated carrier operational mode and shared carrier operational mode. According to one or more embodiments, the sidelink criterion is configured to one of pause and stop the logging of MDT data based at least on one of: the sidelink criterion no longer being met, and expiration of a timer at the wireless device 22. According to one or more embodiments, the MDT data includes a sidelink coverage status that indicates a type of network coverage the wireless device 22 operates under at a time of logging of MDT data where the type of network coverage includes one of in-coverage, out-of-coverage and partial coverage.

According to one or more embodiments, the MDT data includes a sidelink status that indicates whether the wireless device 22 at least one of transmits and receives sidelink signals at a time of logging of MDT data. According to one or more embodiments, the MDT data indicates a sidelink operational mode implemented by the wireless device 22 where the sidelink operational mode is one of a unicast operational mode, multicast operational mode, broadcast operational mode, dedicated carrier operational mode and shared carrier operational mode.

FIG. 9 is a flowchart of an exemplary process in a wireless device 22 according to some embodiments of the present disclosure. One or more blocks described herein may be performed by one or more elements of wireless device 22 such as by one or more of processing circuitry 84 (including the MDT unit 34), processor 86, radio interface 82 and/or communication interface 60. Wireless device 22 is configured to determine whether a sidelink criterion is met, as described herein. Wireless device 22 is configured to initiate logging of minimization of drive test, MDT, data based at least on determining that the sidelink criterion is met, as described herein.

According to one or more embodiments, the sidelink criterion is determined to be met based on the wireless device 22 being configured for a sidelink operation. According to one or more embodiments, the sidelink criterion is determined to be met based on the wireless device 22 actively performing a sidelink operation. According to one or more embodiments, the sidelink criterion is determined to be met based on the sidelink operation being associated with a first sidelink operational mode of a plurality of sidelink operational modes. According to one or more embodiments, the first sidelink operational mode is one of a unicast operational mode, multicast operational mode, broadcast operational mode, dedicated carrier operational mode and shared carrier operational mode.

According to one or more embodiments, the processing circuitry 84 is further configured to one of pause and stop the logging of MDT data based at least on one of: the sidelink criterion no longer being met, and expiration of a timer. According to one or more embodiments, the processing circuitry 84 is configured to start the timer in response to initiating the logging of MDT data. According to one or more embodiments, the MDT data includes a sidelink coverage status that indicates a type of network coverage the wireless device 22 operates under at a time of logging of MDT data, the type of network coverage includes one of in-coverage, out-of-coverage and partial coverage. According to one or more embodiments, the MDT data includes a sidelink status that indicates whether the wireless device 22 at least one of transmits and receives sidelink signals at the time of logging of MDT data.

According to one or more embodiments, the MDT data indicates a sidelink operational mode implemented by the wireless device 22 where the sidelink operational mode is one of a unicast operational mode, multicast operational mode, broadcast operational mode, dedicated carrier operational mode and shared carrier operational mode. According to one or more embodiments, the processing circuitry 84 is further configured to receive the sidelink criterion from a network node 16 for implementation. According to one or more embodiments, the processing circuitry 84 is further configured to cause transmission of MDT data to the network node 16 for use in performing at least one action.

Having generally described arrangements for sidelink based triggering of wireless device measurements such as MDT based measurements, details for these arrangements, functions and processes are provided as follows, and which may be implemented by the network node 16, wireless device 22 and/or host computer 24.

### Scenario

One or more embodiments relate to one example scenario where at least a first wireless device 22a (WD 22a) is capable of SL operation and can be configured to perform SL operation. The scenario may further include one or more additional SL capable wireless devices 22, e.g., a second wireless device 22b (WD 22b). While WD 22b is illustrated as being in a separate cell 18 from the cell 18 that serves WD 22a, in one or more embodiments, WD 22b may be served by the same cell 18 that serves WD 22a and/or may physical close enough to WD 22a to perform SL communication. Hence, one or more WDs 22 (e.g., WD 22a, WD 22b, WD 22c, etc.) may be physically close enough to each other to perform SL communication and may be served by one or more network nodes 16/cells 18.

For example, WD 22b may be configured to perform SL operation with respect to one or more other wireless devices 22 via SL, e.g., with respect to WD 22b on the SL, with respect to WD 22b and WD 22c and so on. For simplicity in describing this scenario, wireless devices 22 may refer to wireless device 22a. In one example, wireless device 22a and other wireless devices 22 (e.g., wireless device 22b) are served by the same network node 16 while in another example they are served by different network nodes 16.

Wireless device 22 may or may not be in the network coverage. When wireless device 22 is in the network coverage then the wireless device 22 can also maintain cellular link with a network node 16, e.g., with its serving network node 16/base station. This is referred to as in-coverage or in-network coverage (INC) SL operation. Otherwise, when the wireless device 22 is not in the network coverage, then wireless device 22 cannot maintain any cellular link with any network node 16. This is referred to as out-of-coverage or out-of-network coverage (ONC) SL operation. The ONC is also referred to as any cell selection state. When wireless device 22 is not in the network coverage, it may operate SL with respect to another wireless device 22 (e.g., WD 22b), which maintains cellular link with a network node 16. This is referred to as partial coverage or partial-network coverage (PNC) SL operation.

Wireless device 22 when in INC is served by a cell (cell1) on a carrier frequency (F1) which is managed by a network node 16 (network node 16a). The resources used by the wireless device 22a for operation on the cellular link is referred to as R1. Wireless device 22a is further configured with sidelink operation on a carrier frequency (F2) using the resources R2. In one example, it is assumed that F1≠F2, i.e., R1 and R2 belong to resources on two different carrier frequencies, e.g., F2 can be a dedicated carrier for SL operation such as ITS band. In another example, it is assumed that F1=F2. In this case, in one example, R1 and R2 are assumed to be time-multiplexed, e.g., SL and cellular resources are time-multiplexed on uplink resources.

### Method in Wireless Device 22 for Initiating Logging of MDT Related Information

In one or more embodiments, wireless device 22 performs a method used for initiating, triggering or starting the logging MDT data (e.g., measurements and related information) based on a criterion (i.e., sidelink operational criterion) related to the configuration of the SL operation. More specifically, wireless device 22 may initiate logging MDT data when one or more of following conditions are fulfilled while the MDT logging timer (e.g., T330) is running:
When wireless device 22 is configured for SL operation by the higher layer (MDT mode #1);
When wireless device 22 is actively operating the SL (MDT mode #2);
When wireless device 22 is configured for SL operation with particular SL operational mode by the higher layer (MDT mode #3);
When wireless device 22 is actively operating SL with particular SL operational mode (s), e.g., unicast operation (MDT mode #4).

This method is described in detail below.

### Criteria for Initiating Logging of MDT Related Information

Compared to legacy MBB wireless device operation, wireless device 22 operation on the sidelink has different characteristics in terms of both mobility and power consumption because wireless device 22 is embedded in a vehicle, which in turn drives wireless device 22's trajectory and provides power to wireless device 22. Therefore, the SL wireless device 22 can be operating in different geographical areas with different speeds, such as highways, tunnels, bridges, etc. The MBB wireless device inside a vehicle may not be able to operate signals in some of these areas or it may operate signals inefficiently, e.g., poor coverage. Another important characteristic of the SL wireless device 22 is that it can be operating in areas where there is no cellular coverage or very poor cellular coverage which makes operation with the legacy MBB wireless device difficult. Therefore, data obtained using existing MDT logging principles do not enable efficient network planning for such geographical areas.

Therefore, according to one or more embodiments of the present disclosure, the configuration of the SL operation in wireless device 22 is used as a criterion for triggering wireless device 22 to initiate the logging of MDT related information. This means wireless device 22 starts logging the MDT data when the SL operation is configured. The configuration may include, for example, allocation or reservation of radio resources for SL operation, which may start immediately or at a future time. The SL operation in wireless device 22 can be configured via wireless device 22's higher layers by one or more of the following mechanisms:
In one example, the SL operation can be configured in wireless device 22 by receiving a configuration message (e.g., RRC message) from network node 16a, e.g., from the serving cell. This applies when wireless device 22 is operating in the in-coverage scenario.
In another example, the SL operation can be pre-configured in wireless device 22, e.g., using USIM card or an application program.
In another example, the SL operation can be configured in the wireless device 22 by receiving a configuration message from another wireless device 22, e.g., from wireless device 22b. This can apply in any network coverage scenario.

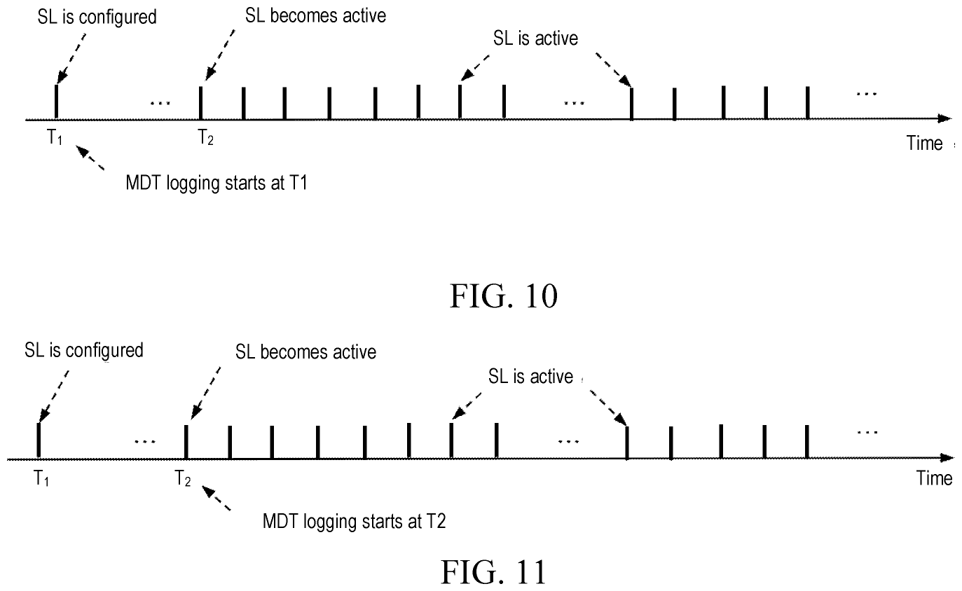

Wireless device 22 may or may not be required to start the SL operation (i.e., transmission and/or reception of SL signals) immediately after wireless device 22 has received the configuration message from its higher layer. Therefore, there can be different modes of MDT logging based at least on the configuration of the SL operation. Non-limiting examples of such MTD modes are described below:
1. In a first example (MDT mode 1 (MDT #1)), wireless device 22 initiates the logging of MDT data upon being configured via higher layer to operate on the SL regardless of whether wireless device 22 has started the actual SL operation (transmission and/or reception of signals) or not. This means the SL has been enabled in wireless device 22 and is ready to operate the SL, but wireless device 22 is currently not engaged in the SL operation. For example, wireless device 22 may be allocated radio resources for SL operation but the actual SL operation may start when certain triggering condition is met, e.g., when wireless device 22 receives higher layer data for transmitting on SL, when wireless device 22 receives signals on SL, etc. FIG. 10 is a diagram of an example where wireless device 22 is configured with SL operation (e.g., radio resources for SL) via higher layers at T1, but wireless device 22 starts the SL operation (transmitting and/or receiving signals on SL) at T2 where T2>T1. Since wireless device 22 is configured with MDT mode #1, therefore wireless device 22 is required to start logging the MDT data at T1.
2. In a second example (MDT mode 2 (MDT #2)), wireless device 22 initiates the logging of MDT data when wireless device 22 is transmitting and/or receiving SL signals. In this case, wireless device 22 is considered to be configured with SL operation if wireless device 22 is configured with SL via higher layer and is also engaged/performing actual SL operation. In one example, wireless device 22 initiates the logging of MDT data upon operating a first SL signal since receiving the SL configuration message. Due to the MDT configuration and/or SL configuration parameters, wireless device 22 may not be able to start logging immediately upon operating the first SL signals. Therefore, in another specific example, wireless device 22 initiates the logging of MDT data as soon as possible after wireless device 22 has operated the first SL signal since the reception of the SL configuration message. In another specific example, wireless device 22 initiates the logging of MDT data upon operating at least K number of SL signals since receiving the SL configuration message. In another specific example, wireless device 22 initiates the logging of MDT data upon operating SL signals over at least certain duration since receiving the SL configuration message, e.g., over L number of time resources such as over 10 slots. FIG. 11 is a diagram of an example where wireless device 22 is configured with SL operation (e.g., radio resources for SL) via higher layers at T1. But wireless device 22 starts the SL operation (transmitting and/or receiving signals on SL) at T2 where T2>T1. Since wireless device 22 is configured with MDT mode #2, therefore wireless device 22 is required to start logging the MDT data at T2 or immediately after T2.
3. In a third example (MDT mode 3 (MDT #3)), wireless device 22 initiates the logging of MDT data upon being configured via higher layer with particular type of SL operation mode even if wireless device 22 has not started the actual SL operation, i.e., transmission and/or reception of signals. One set of examples of SL operation modes are unicast, multicast/groupcast, broadcast, etc. and another set of examples of SL operation modes are SL on shared carrier with Uu, SL on a dedicated carrier such as on a carrier of ITS band, etc.
4. In a fourth example (MDT mode 4 (MDT #4)), wireless device 22 initiates the logging of MDT data when wireless device 22 is actually operating in a particular SL operation mode such as unicast, multicast/groupcast, broadcast or on a dedicated carrier or on a shared carrier, etc. In case of certain events such as accidents (e.g., car accidents), wireless device 22 may have to transmit emergency signals in the multicast or broadcast mode to reach out for emergency help or to inform the other vehicles in the area of the accident/emergency. In this case, it may not be beneficial to initiate the measurements of MDT related information since the vehicles position may be fixed. On the contrary, wireless device 22 may be engaged in SL unicast operation while wireless device 22 is on the road to notify the other vehicles in its vicinity of the accident/emergency, such as in platooning. In this case, it can be beneficial to initiate the measurements of MDT related information.

The above MDT modes and/or MDT modes in accordance with the teachings of the present disclosure can be pre-defined or configured by the network node 16. For example, wireless device 22 can be configured by the network node 16 to log MDT data using any one or more MDT modes (e.g., with ID of pre-defined MDT modes) described in the above examples. In one specific example, wireless device 22 can be configured (or preconfigured) with default MDT mode, e.g., MDT #1. This means that if wireless device 22 is not configured with any specific MDT mode, then wireless device 22 uses the default mode for initiating the MDT logging.

Wireless device 22 may also start a timer (Ts) when it starts logging the MDT data, e.g., Ts may start when a condition for starting the logging based on the configured MDT mode is met.

### Criteria for Stopping Logging of MDT Related Information

In one or more embodiments, wireless device 22 performs a method for stopping, suspending or postponing the ongoing logging of the MDT data. This method allows wireless device 22 to stop, suspend or postpone an already ongoing logging of MDT related information, or already configured logging of MDT related information provided that one or more criteria is met to prevent unnecessary measurements and processing in wireless device 22. Non-limiting examples of such criteria includes:
A condition associated with the configured MDT mode that triggered the start of MDT logging is no longer met. For example, if wireless device 22 is configured with MDT mode #1 and if the SL is deconfigured (e.g., via RRC message) by network node 16 then wireless device 22 stops the logging.
Upon expiry of the timer (Ts) which starts upon starting the logging of the MDT related information. In one example, Ts stops after the logging duration (e.g., fixed duration) regardless of whether the condition associated with the configured MDT mode that triggered the start of MDT logging is met or not. In another example, Ts stops when the condition associated with the configured MDT mode that triggered the start of MDT logging is not met anymore.
Upon changing the network coverage status. For example, if the status changes from IC to PNC, then wireless device 22 may stop the MDT logging.

If wireless device 22 temporarily stops or suspends or pauses the ongoing MDT logging then wireless device 22 may restart or resume the MDT logging. e.g., when one or more conditions to restart the MDT logging are met. The conditions can be the same used for starting the MDT logging. Wireless device 22 may be allowed to restart the MDT logging after the pause provided that the MDT logging timer (e.g., T330) is running; otherwise (i.e., if MDT timer has expired) then wireless device 22 stops MDT logging. The MDT timer starts when wireless device 22 is configured for MDT logging, e.g., initially. As an example, the MDT timer values may vary, e.g., from 1 minute to 480 minutes, etc.

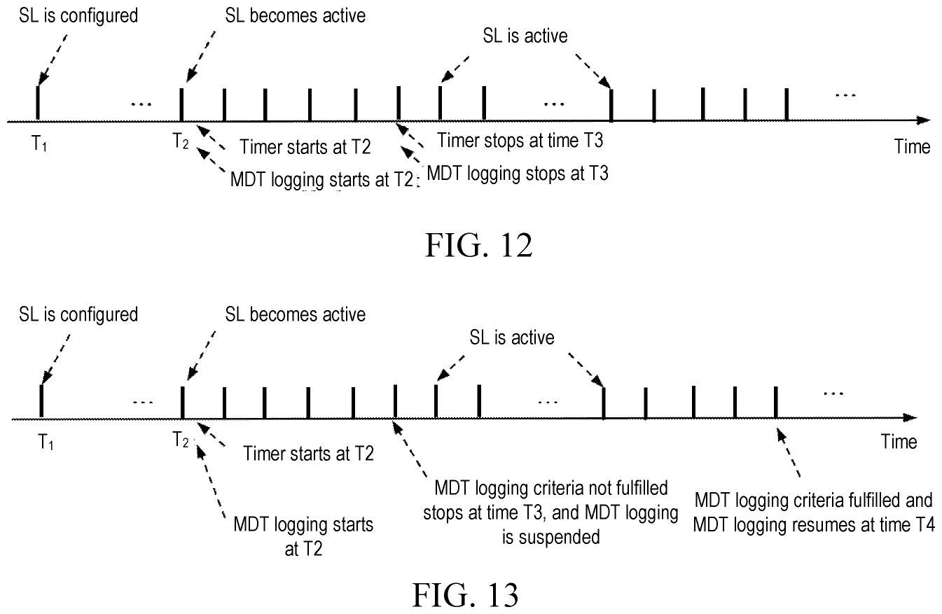

Wireless device 22 may further be configured with any one or more of the above conditions that can be used by wireless device 22 for stopping the MDT logging. If wireless device 22 is not configured with a specific criterion, then it may use a default criterion for stopping or suspending or postponing the logging, e.g., based on expiry of the timer (Ts). In one example, timer Ts may be set for 2 or more hours. FIG. 12 is a diagram of an example where wireless device 22 stops MDT logging after the timer associated with the MDT logging, assuming MDT mode #2.

FIG. 13 is a diagram of another example where MDT logging is suspended and resumed based on MDT logging criteria, assuming MDT mode #2. In particular, the MDT logging is initiated at time T2 upon wireless device 22 fulfilling the criteria for initiating MDT logging at time T2. However, the MDT logging is suspended and resumed at time T3 and T4, respectively, since wireless device 22 failed to fulfill the MDT logging criteria at time T3 and then was able to fulfill those at time T4. In a similar example, wireless device 22 can be allowed to resume the suspended MDT logging only if: |T3−T4|≤ H, where H is a configurable or predefined threshold.

### The Logged MDT Related Information

Wireless device 22 is further configured by the higher layer with information related the MDT related data to be logged by wireless device 22 when the triggering condition is met, e.g., SL is configured. The information to be logged by wireless device 22 may include one or more measurements and associated information. For example, wireless device 22 may be configured by network node 16 with one or more carrier frequencies on which wireless device 22 is required to log the measurement results and related information such the cell IDs, etc. Wireless device 22 logs the MDT data when the triggering condition(s) is met and uses it for one or more operational tasks. Examples of such tasks include transmitting the logged data to the network node 16, e.g., serving base station, transmitting the logged data to another wireless device (e.g., wireless device 22b), using the logged data for internal wireless device 22 operation, etc.

The logged MDT data (measurements and associated information) includes one or more of the following non-limiting examples of parameters:
Result of measurements performed on one or more cells e.g., RSRP, RSRQ, SINR, SNR, BLER, etc.
Cell ID, e.g., PCI and/or CGI of cells on which measurement is performed.
Time stamp or relative time stamp when SL was configured.
Time stamp or relative time stamp when the logging starts.
SL status when certain measurement(s) were logged.
SL operation mode when certain measurement(s) were logged.
MDT mode used for logging data.
Network coverage status when certain measurement(s) were logged
Wireless device 22 mobility status, e.g., wireless device 22 speed at the time of logging.
Wireless device 22 location (e.g., geographical coordinates) at the time of logging.
Duration of the log. In one example, this may correspond to the duration over which the SL operation remains configured. In another example, it may be any configurable value, e.g., 60 minutes.

### Examples of Logging MDT Related Information

The logging of MDT data based on one or more of the above embodiments is described below in detail with several examples.

### Logging Example #1:

A general example is shown in Table 1 (below) where wireless device 22 is configured to log MDT related information, and the logged information include: SL status (SL_STATⱼ), relative time (ΔTⱼ), and cell ID (IDⱼ). It is assumed that wireless device 22 can log up to N values of the cell IDs over the logging duration, e.g., ID₁, ID₂, ID₃, . . . , ID_{N}, over time instances T₁, T₂, T₃, . . . , T_{N} respectively, therefore j≤N. The relative time with respect to Tr for logging Nj is denoted as ΔTⱼ. ΔTj is also referred to as logging time with respect to reference time, Tr. For example, Tr can be the absolute time in the serving cell 18 when wireless device 22 is configured by the network node 16 for logging MDT data. In another example, Tr can be any type of absolute time with which wireless device 22 is configured by the network node 16 for logging MDT data, e.g., UTC time. As an example, ΔTⱼ=(Tⱼ−Tr) e.g., ΔT₁=(T₁−Tr) and so on. As special case ΔT₁=ΔT₂= . . . =ΔT_{N}. e.g., the logging period or interval may include a L number of DRX cycle or it can be a fixed value. The logging starts when the SL operation is configured, e.g., based on one of the configured MDT modes, e.g., MDT modes #1, 2, 3 or 4 (as described earlier). Wireless device 22 may further be configured with a logging duration, e.g., total duration over which the logging is to be performed. In one example, the logging stops when the SL operation is deconfigured by wireless device 22's higher layers.

TABLE 1
A general example of logged results associated
with MDT related information

| Logged | | Relative | |
|---|---|---|---|
| results set | SL Status | time | Cell ID |
| (Sj) | (SL_STATⱼ) | (ΔTⱼ) | (IDⱼ) |
| 1 | SL_STAT₁ | ΔT₁ | ID₁ |
| 2 | SL_STAT₂ | ΔT₂ | ID₂ |
| . . . | . . . | . . . | . . . |
| K | SL_STAT_{K} | ΔT_{K} | ID_{K} |
| K + 1 | SL_STAT_{K+1} | ΔT_{K+1} | ID_{K+1} |
| K + 2 | SL_STAT_{K+2} | ΔT_{K+2} | ID_{K+2} |
| . . . | . . . | . . . | . . . |
| N | SL_STAT_{N} | ΔT_{N} | ID_{N} |

The SL status, SL_STATⱼ indicates the status of the SL at the time of the logging, e.g., 0 indicating that wireless device 22 was neither transmitting nor receiving SL signals at the time of logging, and 1 indicating wireless devices 22 was transmitting and/or receiving SL signals at the time of logging.

### Logging Example #2:

Table 2 is another general example where wireless device 22 is configured to log MDT related information and some relevant SL and Uu related data. The logged information includes SL mode (SL_Modeⱼ), relative time (ΔTⱼ), cell ID (IDⱼ), and measurement results (Mⱼ). The measurement results (Mᵢ) include one or more of signal strength measurement (RSRP), signal quality measurements (RSRQ), SNR, SINR, etc., of one or more cells on the Uu link. The SL operation mode herein indicates one of unicast, multicast/groupcast, broadcast mode of operation, etc. Similarly, the logged information may also include the type of SL signals and/channels being transmitted on SL at the time of MDT logging. Examples of such signals/channels are SL synchronization signals, SL data channel, SL control channel, etc. In another example, the logged information may also include type of carrier used for SL operation at the time of logging, e.g., dedicated carrier, shared carrier shared between SL and Uu, etc. The carrier frequency can be indicated by a frequency channel number, e.g., ARFCN.

TABLE 2
A general example of logged measurement results
associated with MDT related information

| Logged | | | Relative | Cell |
|---|---|---|---|---|
| results set | SL Mode | Measurement | time | ID |
| (Sj) | (SL_Modeⱼ) | result (Mⱼ) | (ΔTⱼ) | (IDⱼ) |
| 1 | N₁ | M₁ | ΔT₁ | ID₁ |
| 2 | N₂ | M₂ | ΔT₂ | ID₂ |
| . . . | . . . | . . . | . . . | . . . |
| K | N_{K} | M_{K} | ΔT_{K} | ID_{K} |
| K + 1 | N_{K+1} | M_{K+1} | ΔT_{K+1} | ID_{K+1} |
| K + 2 | N_{K+2} | M_{K+2} | ΔT_{K+2} | ID_{K+2} |
| . . . | . . . | . . . | . . . | . . . |
| N | N_{N} | M_{N} | ΔT_{N} | ID_{N} |

In another example as shown in Table 3 (below), the logged MIDT related information may also include SL measurement (Sᵢ) results of measurements on SL signals in addition to the WAN measurement results (Wᵢ) of measurements on Uu signals. Examples of SL measurements are sidelink RSRP (SL-RSRP), sidelink RSRQ (SL-RSRQ), sidelink received signal strength indicator (SL-RSSI), channel busy ratio (SL-CBR), SL channel occupancy ratio (SL-CR), etc., as shown in Table 3.

TABLE 3
A general example of logged measurement results
associated with MDT related information

| Logged | | SL | WAN | Relative | Cell |
|---|---|---|---|---|---|
| results | SL Mode | Measurement | Measurement | time | ID |
| set (Sj) | (SL_Modeⱼ) | result (Mⱼ) | result (Wⱼ) | (ΔTⱼ) | (IDⱼ) |
| 1 | N₁ | S₁ | W₁ | ΔT₁ | ID₁ |
| 2 | N₂ | S₂ | W₂ | ΔT₂ | ID₂ |
| . . . | . . . | . . . | . . . | . . . | . . . |
| K | N_{K} | S_{K} | W_{K} | ΔT_{K} | ID_{K} |
| K + 1 | N_{K+1} | S_{K+1} | W_{K+1} | ΔT_{K+1} | ID_{K+1} |
| K + 2 | N_{K+2} | S_{K+2} | W_{K+2} | ΔT_{K+2} | ID_{K+2} |
| . . . | . . . | . . . | . . . | . . . | . . . |
| N | N_{N} | S_{N} | W_{N} | ΔT_{N} | ID_{N} |

### Logging Example #3:

Another general example of the logging of MDT related information is provided in Table 4 (below). Compared to the previous examples above in Tables 1-3, this example also includes the logging of the SL coverage status. Sidelink coverage status may have any one of the values: in-coverage, out-of-coverage and partial coverage. The sidelink coverage status indicates that at the time of the logging certain measurement wireless device 22 was operating sidelink under network coverage, out-of-network coverage or under partial network coverage (e.g., using wireless device 22 relays) respectively.

TABLE 4
A general example of logged measurement results
associated with MDT related information

| | SL coverage | Measurement | Relative | Cell |
|---|---|---|---|---|
| | status | result (Mⱼ) | time | ID |
| 1 | (SL_Covⱼ) | [dBm] | (ΔTⱼ) | (IDⱼ) |
| 2 | N₁ | W₁ | ΔT₁ | ID₁ |
| . . . | N₂ | W₂ | ΔT₂ | ID₂ |
| K | . . . | . . . | . . . | . . . |
| K + 1 | N_{K} | W_{K} | ΔT_{K} | ID_{K} |
| K + 2 | N_{K+1} | W_{K+1} | ΔT_{K+1} | ID_{K+1} |
| . . . | N_{K+2} | W_{K+2} | ΔT_{K+2} | ID_{K+2} |
| N | . . . | . . . | . . . | . . . |
| 1 | N_{N} | W_{N} | ΔT_{N} | ID_{N} |

### Logging Example #4:

Table 5 (below) illustrates an example where wireless device 22 is configured to log MDT related information on cells detected on the cellular carrier. In this example, the logging is performed periodically every 5120 ms for logging duration of 40960 ms, i.e., 8 logged values. The first log also starts at 5120 ms with respect to the reference time. Wireless device 22 is configured to log SS-RSRP on certain Uu carrier, e.g., serving carrier (F1). In the example in Table 5, wireless device 22 logs the measurement results of the detected cell on F1 while wireless device 22 is operating on the sidelink (e.g., as vehicle is moving along the highway). Wireless device 22 is also configured to log the SL status information. The SL coverage status levels: ONC, IC and PNC are denoted in this example by their corresponding identifiers #0, #1 and #2 respectively.

Wireless device 22 changes the serving cell from cell with ID #0 to another cell with ID #1 after the relative time ΔT₄=20480 with respect to the reference time. For simplicity, SS-RSRP results are shown only for the serving cell.

Table 5 illustrates that after ΔT₆=30720, wireless device loses the serving cell due to lack of coverage and enters a ONC scenario. Therefore, wireless device 22 logs SL coverage status as ‘1’ and SS-RSRP below −156 dBm, because as an example −156 dBm is the lowest possible measurable SS-RSRP value.

TABLE 5
A specific example of logged measurement results
associated with MDT related information

| Logged | SL coverage | | Relative | Cell |
|---|---|---|---|---|
| results set | status | Measurement result | time | ID |
| (Sj) | (SL_Covⱼ) | (SS-RSRP) [dBm] | (ΔTⱼ) | (IDⱼ) |
| 1 | 0 | −90 ≤ SS-RSRP < −89 | 5120 | 0 |
| 2 | 0 | −70 ≤ SS-RSRP < −69 | 10240 | 0 |
| 3 | 0 | −95 ≤ SS-RSRP < −94 | 15360 | 0 |
| 4 | 0 | −110 ≤ SS-RSRP < −109 | 20480 | 0 |
| 5 | 0 | −120 ≤ SS-RSRP < −119 | 25600 | 1 |
| 6 | 0 | −130 ≤ SS-RSRP < −134 | 30720 | 1 |
| 7 | 1 | SS-RSRP < −156 | 35840 | 1 |
| 8 | 1 | SS-RSRP < −156 | 40960 | 1 |

One or more example methods in a network node 16 of using logged MDT data as described below.

Network node 16 obtains the MDT data logged by wireless device 22 when wireless device 22 transmits the data to network node 16, e.g., when wireless device 22 goes into RRC connected state.

Network node 16 uses the obtained data for one or more operational tasks. Examples of such tasks include one or more of:
Transmitting the received information (i.e., at least some of the MDT data logged by wireless device 22) to another network node 16, which may be logical or physical node (e.g., node responsible for SON function).
Tuning and optimization of one or more parameters related to the existing radio network (e.g., already deployed network nodes 16) to enhance the existing network coverage. Examples of parameters are network node 16 transmit power, network node 16 antenna configuration, network node 16 receiver, network node 16 beam management (e.g., adapting one or more of: beam width, beam directions, number of beams, etc.). For example, in a location where the SL operation is used by wireless device 22 (e.g., SL status is ON) but cellular coverage is poor (e.g., SS-RSRP below threshold) the network node 16 adapts one or more parameters to improve the coverage, e.g., increases network node 16's (e.g., base station) transmit power by a certain threshold. In another example, if wireless device 22 speed is higher than certain threshold in certain areas (e.g., motorway) then network node 16 or the network may enhance the receiver of network node 16 in that area to be able to handle higher wireless devices 22 speed, e.g., by enhancing Doppler estimation algorithm in the receiver of the network node 16.
Extending existing network coverage or installing new network nodes 16 (e.g., radio nodes, base station, RRH, etc.) in areas with the coverage holes. For example, in a location where the SL operation is used by wireless device 22 (e.g., SL status is ON) but cellular coverage is non-existent (e.g., SS-RSRP below lowest value) new network nodes 16 (e.g., base station(s)) can be installed to help ensure that wireless device 22's can have cellular coverage.
Tuning and optimization of one or more parameters related to the existing infrastructure assisting SL operation, e.g., road side unit (RSU). For example, in location where the SL operation is used more frequently and/or where network coverage is poor (e.g., ONC or PNC, etc.), the parameters such as transmit power of the existing RSUs can be increased by a certain threshold. This is to compensate for the lack of assistance or limited assistance from the serving cell 18 due insufficient cellular network coverage.
Extending existing infrastructure or deploying more network nodes 16 for assisting SL operation, e.g., RSU. For example, in location where the SL operation is used by wireless device 22 (e.g., SL status is ON) but cellular coverage is non-existent, the new network nodes 16 (e.g., RSU) can be installed to ensure robust SL operation even without assistance from the cellular network.

The embodiments described herein are applicable for any type of D2D operation including ProSe, V2X, etc.

One or more embodiments described herein provide one or more of the following advantages over existing systems:
Enhanced MDT data that is obtained can be used for improving cellular network planning in geographical areas used for vehicles, e.g., motorways, tunnels, etc.
The performance of MBB wireless devices is enhanced due to improved cellular network planning and optimization of parameters based on SL triggered MDT measurements.
The network node 16 and/or network operator receive more accurate information about the actual network coverage levels as experienced by the wireless devices 22.
The network node 16 can use the reported logged information for optimizing the network parameters.
Enables the network/network node to enhance and improve the efficiency of radio resources.
Takes advantage of SL V2X wireless device mobility profile that may be a much broader mobility profile compared to the mobility profile of an MBB wireless device.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviations Explanation

ANR Automatic neighbor relations
AP Access point
ARFCN Absolute Radio Frequency Channel Number
BCH Broadcast channel
BLER Block error rate
BS Base station
BSC Base station controller
BTS
CGI
Base transceiver station
Cell global identity
CP Cyclic prefix
D2D Device to device
DL Downlink
DRX Discontinuous reception
EARFCN Evolved absolute radio frequency channel number
eNodeB eNB
FDD Frequency division duplex
INC In-network coverage
MBB Mobile broadband
MDT Minimization of drive tests
MME Mobility management entity
SI System Information
SL Sidelink
ONC
Out-of-network coverage
Physical cell identity
PCI
PCell Primary Cell
PNC Partial network coverage
RAT Radio Access Technology
RF Radio frequency
RNC Radio Network Controller
RRC Radio resource control
RRH Remote radio head
RRU Remote radio unit
RSRP Reference Signal Received Power
RSRQ Reference Signal Received Quality
RSSI Received signal strength indication
RSTD Reference signal time difference
RSU Roadside unit
SI System information
SINR Signal to interference and noise ratio
SON Self-organizing networks
SSS Secondary synchronization signal
TDD Time division duplex
Tx Transmitter
UARFCN UMTS Absolute Radio Frequency Channel Number
UE User equipment
UL Uplink
WAN Wireless access network

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A wireless device, comprising:
processing circuitry configured to:
determine whether a stopping criterion of logging of minimization of drive test, MDT, data is met; and
stop logging of MDT data based at least on determining that the criterion is met.

2. The wireless device of claim 1, wherein the stopping criterion comprises one of the following:
expiration of a timer which started upon starting logging of MDT data;
a condition associated with a configured MDT mode that triggered the starting of logging of MDT data is no longer met; and
changing of current network coverage status.

3. The wireless device of claim 2, wherein the processing circuitry is further configured to:
determine whether a suspending or postponing criterion of logging of MDT data is met; and
suspend or postpone an ongoing logging of MDT data based at least on determining that the suspending or postponing criterion is met.

4. The wireless device of claim 3, wherein the processing circuitry is further configured to:
restart or resume the logging of MDT data when one or more conditions to trigger restarting or resuming the logging of MDT data are met.

5. The wireless device of claim 2, wherein the condition associated with a configured MDT mode that triggered the starting of logging of MDT data comprises: the wireless device has been configured with sidelink, SL, operation and starts to operate the first SL signal.

6. The wireless device of claim 2, wherein the
condition associated with a configured MDT mode that triggered the starting of logging of MDT data relates to a specific SL mode or type of carrier on which is operated by the wireless device, where the specific SL mode comprises any of unicast, multicast, groupcast and broadcast, where the specific type of carrier comprises any of dedicated carrier or shared carrier.

7. (canceled)

8. The wireless device of claim 2, wherein the network coverage status comprises one of in-coverage, out-of-coverage and partial coverage.

9.-11. (canceled)

12. The wireless device of claim 1, wherein the MDT data includes at least one of:
a cellular measurement result;
a sidelink measurement result;
a cell identifier of a cell on which the cellular measurement is performed;
information associated with a sidelink wireless device on which a sidelink measurement is performed;
a time when the sidelink operational criterion is met;
a time when the MDT data is logged;
wireless device mobility status when the MDT data is logged;
wireless device location information when the MDT data is logged; and
a duration over which the MDT data is logged.

13. (canceled)

14. A network node, comprising:
processing circuitry configured to:
configure a wireless device with a stopping criterion of logging of MDT data and a condition associated with a configured MDT mode that triggered the starting of logging of MDT data;
receive MDT data; and
perform at least one action based on the received MDT data.

15. The network node of claim 14, wherein the stopping criterion comprises one of the following:
expiration of a timer which started upon starting logging of MDT data;
a condition associated with a configured MDT mode that triggered the starting of logging of MDT data is no longer met; and
changing of current network coverage status.

16. The network node (46) of claim 15, wherein the condition associated with a configured MDT mode that triggered the starting of logging of MDT data comprises: the wireless device has been configured with sidelink, SL, operation and starts to operate the first SL signal, or
wherein the condition associated with a configured MDT mode that triggered the starting of logging of MDT data relates to a specific SL mode or type of carrier on which is operated by the wireless device, where the specific SL mode comprises any of unicast, multicast, groupcast and broadcast, where the specific type of carrier comprises any of dedicated carrier or shared carrier.

17.-19. (canceled)

20. The network node of claim 14, wherein the MDT data includes a sidelink coverage status that indicates a type of network coverage the wireless device operates under at a time of logging of MDT data, the type of network coverage includes one of in-coverage, out-of-coverage and partial coverage.

21. (canceled)

22. The network node of claim 14, wherein the MDT data indicates a sidelink operational mode implemented by the wireless device, the sidelink operational mode being one of a unicast operational mode, multicast operational mode, broadcast operational mode, dedicated carrier operational mode and shared carrier operational mode.

23. (canceled)

24. A method implemented by a wireless device, the method comprising:
determining whether a stopping criterion of logging of minimization of drive test, MDT, data is met; and
stopping logging of MDT data based at least on determining that the criterion is met.

25. The method of claim 24, wherein the stopping criterion comprises one of the following:
expiration of a timer which started upon starting logging of MDT data;
a condition associated with a configured MDT mode that triggered the starting of logging of MDT data is no longer met; and
changing of current network coverage status.

26. The method of claim 24, wherein the condition associated with a configured MDT mode that triggered the starting of logging of MDT data comprises: the wireless device has been configured with sidelink, SL, operation and starts to operate the first SL signal; or
wherein the condition associated with a configured MDT mode that triggered the starting of logging of MDT data relates to a specific SL mode or type of carrier on which is operated by the wireless device, where the specific SL mode comprises any of unicast, multicast, groupcast and broadcast, where the specific type of carrier comprises any of dedicated carrier or shared carrier.

27.-32. (canceled)

33. The method of claim 24, wherein the MDT data indicates a sidelink operational mode implemented by the wireless device, the sidelink operational mode being one of a unicast operational mode, multicast operational mode, broadcast operational mode, dedicated carrier operational mode and shared carrier operational mode.

34. The method of claim 24, further comprising receiving the stopping criterion of logging of MDT data and the condition associated with a configured MDT mode that triggered the starting of logging of MDT data from a network node.

35. The method of claim 24, wherein the MDT data further includes at least one of:
a cellular measurement result;
a sidelink measurement result;
a cell identifier of a cell on which the cellular measurement is performed;
information associated with a sidelink wireless device on which a sidelink measurement is performed;
a time when the sidelink operational criterion is met;
a time when the MDT data is logged;
wireless device mobility status when the MDT data is logged;
wireless device location information when the MDT data is logged; and
a duration over which the MDT data is logged.

36.-46. (canceled)
